(19) United States
(12) Patent Application Publication
(10) Pub. No.: US 2012/0304379 A1
(43) Pub. Date: Dec. 6, 2012

(54) SYSTEM AND METHOD FOR FACILITATING MOVEMENT OF A PERSON LYING DOWN ON A SUPPORT MEMBER

(76) Inventor: Luis A. CHAPMAN, MADISON HEIGHTS, MI (US)

(21) Appl. No.: 13/481,178

(22) Filed: May 25, 2012

Related U.S. Application Data
(60) Provisional application No. 61/519,970, filed on Jun. 1, 2011.

(51) Int. Cl. A61G 7/10; A47G 9/08

(52) U.S. Cl. 5/81.1 R

(57) ABSTRACT

A turning and movement facilitating system and apparatus is usable to improve flexibility of body movement of a person lying on a bed or other support member. The apparatus includes a short trouser component wearable by a user, and a layer of bedding material. The short trouser component is attached to the person around his or her lower torso, and the layer of bedding material is attached to a bed or sleeping bag. Both components of the system include thin, single layer sheets of nylon or other fabric material that has a low coefficient of friction. When both of these materials are in contact, ease of movement will occur. Thus, a person can easily rotate to any degree and turn to any angle in relationship to the bed. A method of using the system to facilitate movement is also disclosed.

### CROSS-REFERENCE TO RELATED APPLICATIONS

The present application claims priority under 35 U.S.C. 119(e), based on U.S. provisional patent application 61/519,970, filed 1 Jun. 2011. The entire disclosure of this priority document, including specification, claims, and drawings, is incorporated by reference herein.

### BACKGROUND OF THE INVENTION

The present invention relates to a system and method for facilitating movement of a person lying down on a bed or other support member, and is related to the general field of low friction bed draw-sheets. The disclosed embodiments of the present invention advance this field, by allowing a user to either turn themselves over with minimal effort, or otherwise orient themselves at any body angle position while sleeping on the bed or support member.

Such maneuvering for position is accomplished using a combination of a low-friction draw-sheet, which is either attached to a bed top surface or sewn into a central portion of a sleeping bag, and a low-friction short trouser sheet attached to, and worn by the user. The present invention is intended primarily for use by infirm or debilitated individuals, but can also be useful to others: for example, persons who wish to exert less effort while sleeping, or persons who sleep in small confined spaces.

In the field of draw-sheets and bedding devices, many ideas for turning and movement in bed have been disclosed. A major reason for most of their effectiveness has been the use of frictionless materials with low coefficient of friction. They include these materials in some way or fashion. For example, Smith's U.S. Pat. No. 4,944,053 describes a multi-layered tubular device which allows a person so shift side to side. Smith, U.S. Pat. No. 5,123,113 discloses a selective body portion protecting means for use with any one of a number of specified body parts to prevent friction on a wound, burn, bedsore, or similar affliction. Another multi-layered device in the form of a draw-sheet is described by Lindberg U.S. Pat. No. 5,787,523. Both of these devices allow the shifting of a person only from side to side in one plane. Two other methods, Neilson's U.S. Pat. No. 3,849,813 and Servais U.S. Pat. No. 7,849,532, describe two-layered draw sheets with a low and high friction sides. These devices were designed for people to attempt to slide out of bed and the natural physics is not clear. A person using these devices will have to contend with the high coefficient of friction created by their clothing or skin. Therefore, their maneuverability is significantly reduced with annulment of the frictionless bed-cover materials.

### SUMMARY OF THE INVENTION

One object of the present invention is that in order to improve movement and turning while sleeping, a system provides two contacting surface sides, each formed from a slippery material. Furthermore, to facilitate natural sleeping movements, these two sides must be separate and move independently of each other. This will allow a person to turn any amount such as 90 degrees, 180 degrees such as moving from supine to prone; or to simply turn from side to side; to completely rotate 360 degrees, if needed, or to shift to any angle with respect to the bed.

This can be achieved by using a first layered low-friction material that can be easily worn as short trousers, and by attaching a second portion of single layered low-friction material to a bed or other support substrate, such as a sleeping bag. This second portion of low-friction material needs to only be the width of the trousers being used. Studies have shown that nylon a low coefficient of friction as compared to other fabrics, so nylon is one preferred material in the practice of the present invention. It is also durable and easily washed.

The present invention provides an improved movement-facilitating system which allows a user to more easily maneuver his or her body while sleeping. This will allow a debilitated or non-debilitated person to move in their bed with ease on their own. The use of a short trouser worn by a person and a separate layer of cooperating material attached to the bed, or other resting support, will allow the user to rotate to any degree or at any angle while sleeping on the bed or support. This will make sleeping more comfortable for some and reduce the energy and pain of movement for others.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1A is a perspective view of a movement-facilitating system according to a selected illustrative embodiment of the present invention.

FIG. 1B is a perspective view of a first fabric member which is a first component of the movement-facilitating system of FIG. 1A.

FIG. 1C is a perspective view of a second fabric member which is a second component of the movement-facilitating system of FIG. 1A.

FIG. 2 is a partial perspective view of a person's torso wearing the first fabric member of FIG. 1B.

FIG. 3 is a perspective view of the second fabric member attached to a bed using drawstrings 12.

FIG. 4 is a perspective view of a person wearing the first fabric member and lying on a bed with the first fabric member disposed on top of the second fabric member of the disclosed movement-facilitating system.

FIG. 5 is a perspective view of a person using the disclosed movement-facilitating system to illustrate its capability to complete a 360 degree revolutionary movement in any direction from its central core. This includes turning from side to side for comfort.

FIG. 6 is a perspective view of the same person using the disclosed movement-facilitating system to illustrate its capability to pivot or turn to any angle with respect to a longitudinal center line of the bed.

FIG. 7 is a perspective view of a sleeping bag including a portion of a second embodiment of the present invention, with a second fabric member shown in phantom.

FIG. 8 is a top plan view of the sleeping bag of FIG. 7, showing a second fabric member disposed therein.

FIG. 9 is a diagram showing steps in an illustrative method according to the invention.

### DETAILED DESCRIPTION

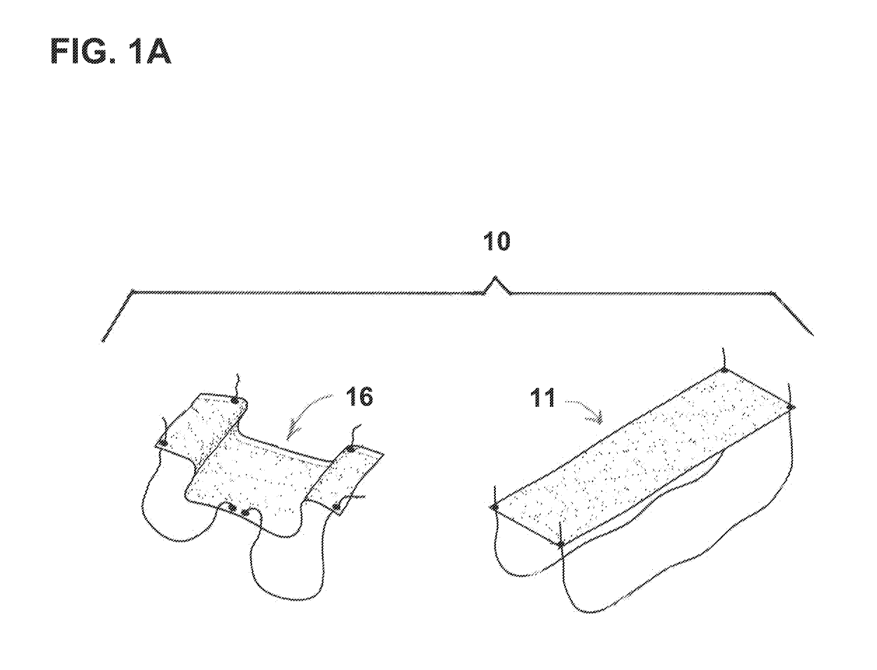

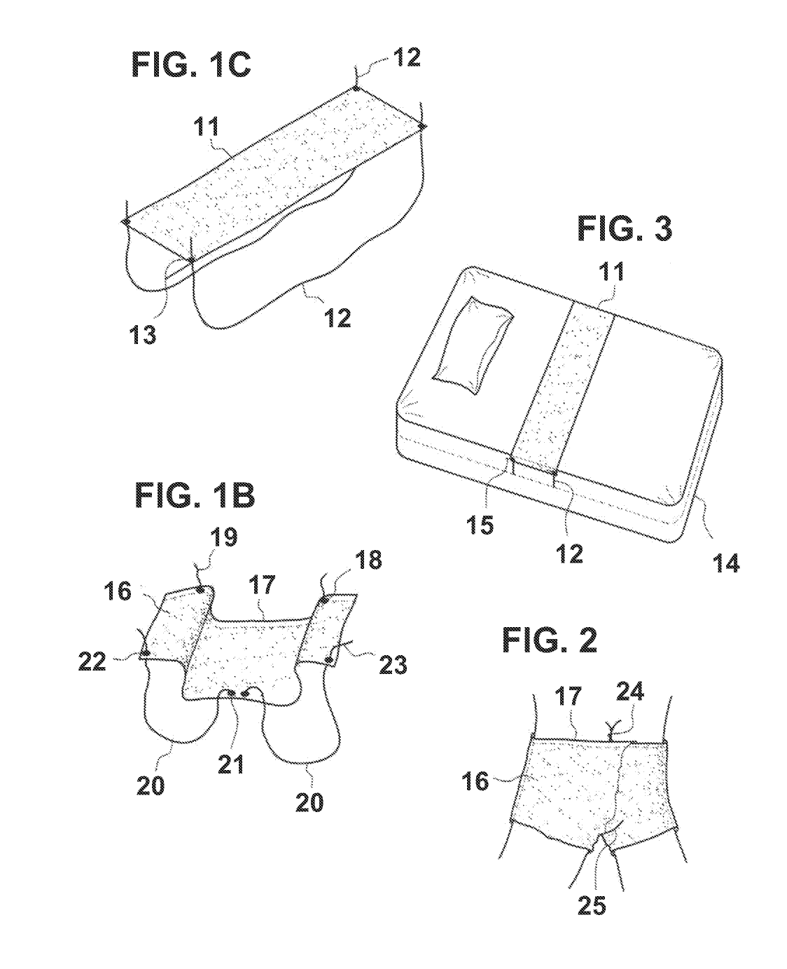

A first embodiment of a turning and movement facilitating system is shown at 10 in FIG. 1, and the system 10 includes two separate components. A first component of the system 10 is a first fabric member 16 configured to be wearable by a user at a lower torso portion of the body, and which may be worn by a person as a pair of shorts for sleeping. Alternatively, the first fabric member 10 may be wrapped externally around other clothing such as pajamas, if desired.

The system 10 according to the first embodiment also includes a second fabric member 11, including a thin single membrane material that is provided for attachment to a bed 14, or other resting support member.

These two components are made of a low-friction fabric, like canvas nylon, that allows the first and second fabric members 16, 11 to slide against each other effectively with a minimal amount of friction therebetween. This allows for ease of mechanical movement.

FIG. 2 is a perspective view of the first fabric member 16 being worn as shorts. In the embodiment of FIG. 2, the first fabric member 11 includes a single-layered piece of canvas nylon fabric of a sufficient size, width and length, to fit around a user's lower torso, as shown. The upper end of the first fabric member 11 has an open-ended hem 17 and metal eyelets 18, that houses an elastic drawstring 19 which is used to tie the first fabric member 11 around a person's lower torso below the waist. The lower end of the first fabric member 11 has two separate drawstrings 20 thereon, with one end 21 attached at a middle portion of the first fabric member 11, and the other end 23 courses through one of a pair of metal eyelets 22. These also allow for elastic strings to secure the lower end of the first fabric member 11 around the thighs of the user. The respective strings 19, 23 can be tied separately at the top 24 and the bottom 25 of the first fabric member 11. Any excess fabric is secured conveniently under the trousers' edge or with hook and loop fasteners, such as those sold under the trademark “Velcro”.

The strings 19, 23 are one example of a type of fastener which may be used to connect opposite ends of the first fabric member 11 together to make it fit snugly around the torso of a user. Non-limiting examples of suitable fasteners which are usable to connect first and second ends of the first fabric member 11 together include tie strings, snaps, hook and loop fasteners, and releasably securable plastic closure members, such as plastic side release buckles with corresponding adjustable straps.

One advantage of using the first fabric member 11 as a strip of material as shown in FIG. 1C, rather than as a custom-made piece of clothing made in a specific size, is that a single sized fabric strip, such as the one shown, can be adjustably worn by different persons of different sizes, and therefore, a vendor would not be required to maintain an inventory of many different sized garments for different users. Similarly, where the present invention is used in an institutional setting, a much smaller total number of fabric members are required to be kept in reserve, if a single fabric member may be adjusted to fit persons of different sizes.

FIG. 3 is a perspective view of the second fabric member 11 attached to a bed 14 using drawstrings 12. It can be secured using clamps or a tie knot 15 by inserting the drawstring 12 through adjacent metal eyelets 13. This process will keep the sheet secured, stable and immobile during most movements of a user.

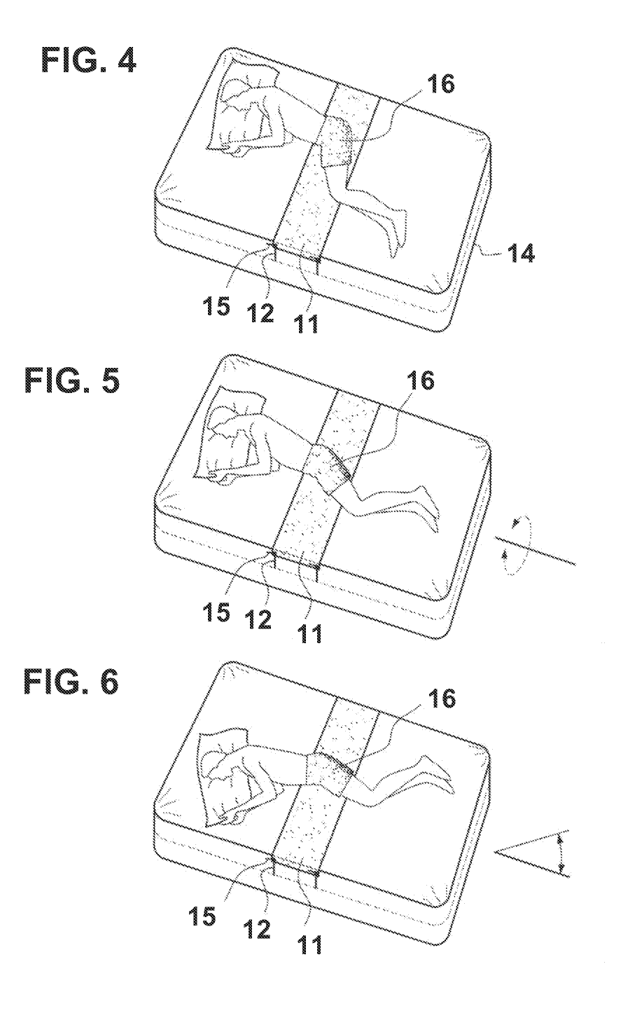

FIG. 4 is a perspective view of a person using the disclosed device to illustrate its capability to complete a 360 degree revolutionary movement in any direction from its central core. This includes turning from side to side for comfort.

FIG. 5 is a perspective view of the same person's capability to pivot or turn to any angle with respect to a central line of the bed.

### Operation:

The bed turning and movement apparatus requires two separate pieces in order for it to function as is described above. First, the low friction sheet must be secured to the bed. And second, the low friction trousers must be worn. The device is ideal for post-operative patients or for debilitated individuals with, for example, back, knee or hip pain. Furthermore, this device can be used by any non-debilitated persons who want the ease of moving in bed. When both the sheet and the trouser are juxtaposed to each other, the sliding capability of the low friction material will allow ease of turning into any position or angle.

The draw-sheet is simply laid on the bed and attached via various methods. In the depicted embodiment, two separate pieces of draw strings are pulled between the bed mattress and box spring and securely tied to respective lateral ends of the draw-sheet. This will keep the draw sheet from moving out of place during aggressive shifting of a person laid in the bed.

The trouser component can be easily fitted to a person while standing, sitting or laying in bed. The upper portion is tied using the elastic drawstring around the waist. The lower portion is tied using a separate elastic draw-string around each thigh, respectively.

To rotate to any degree, a person may first twist his hips at any comfortable rate. Then, using the upper and lower body parts, one may complete the rotation of the body to the sides, prone or supine positions.

Because of the length of the draw-sheet, a person may also navigate towards the end or middle of the bed by sliding movements.

For people sleeping on confined spaces like cots or sleeping bags, the apparatus may facilitate turning for the sake of comfort.

For people having upper body disability, a similar device may be worn as a vest instead of, or in addition to the described trousers 16 to enable movement. In such case, however, the draw-sheet will have to be positioned further up in the bed, at the level of the vested chest location.

A second person can also utilize the properties of the invention to move incapacitated and bed-bound people with less effort or risk for self-injury.

In one embodiment, the present invention provides a movement-facilitating system for facilitating ease of a user's movement while the user is lying down on a support member. The system includes a first fabric member configured to be wearable by the user. The first fabric member includes a wrap cloth having an outer fabric surface having a low coefficient of friction and having a first fastener thereon at a first portion and a second fastener at an end portion thereof which is removably attachable to the first fastener.

The system also includes a second fabric member for placement traversing a portion of the support member. The second fabric member includes a sheet member having an upper fabric surface having a low coefficient of friction; and a sheet fastening component for use in operatively attaching the sheet member to a central portion of the support member.

The first and second fasteners of the first fabric member may be selected from the group consisting of tie strings, snaps, hook and loop fasteners, and releasably securable plastic closure members such as side-release buckles with corresponding straps.

Similarly, the sheet fastening component of the second fabric member may be selected from the group consisting of hook and loop fasteners, tie strings, elastic bands with clip ends thereon (similar to suspender clips), and side-release buckles with corresponding straps.

In one embodiment, the second fabric member is configured to fit on a bed.

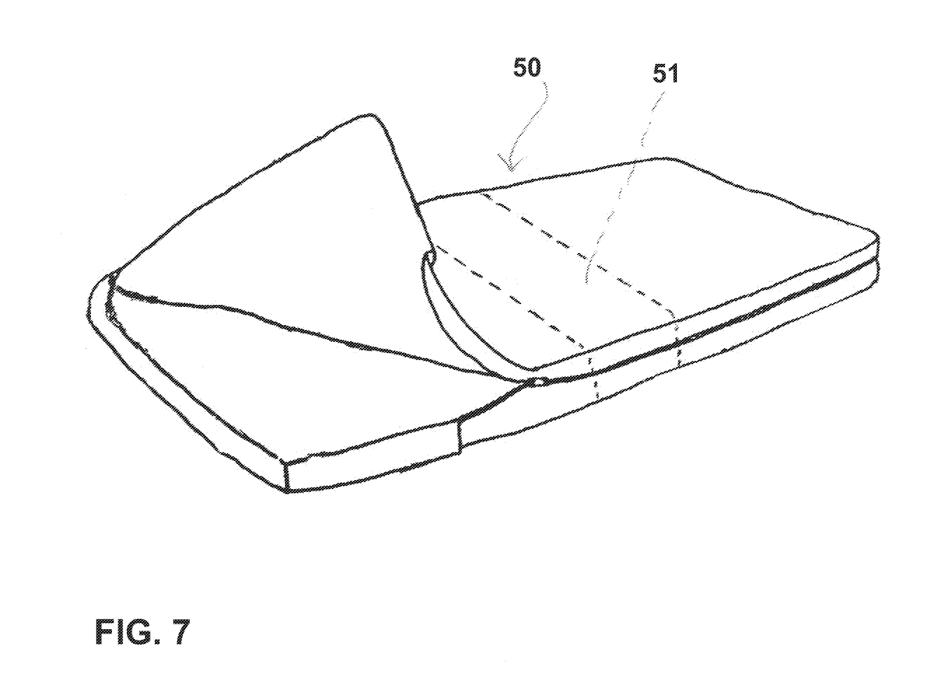

Referring now to FIGS. 4-6, a user is shown wearing the first fabric member 16 around a lower portion of the torso, similar to a pair of shorts, and lying on a bed 14 with the second fabric member 11 installed thereon. The low friction type of interaction between the first and second fabric members 16, 11 makes it easy for the user to slidably move from side to side on the bed, or to rotate from one side to another as suggested by the arrow in FIG. 5, by any selected amount of rotation. Alternatively, as suggested by the arrow in FIG. 6, the user may easily adjust the angle at which he or she is oriented relative to the support surface of the bed.

### Sleeping Bag Embodiment

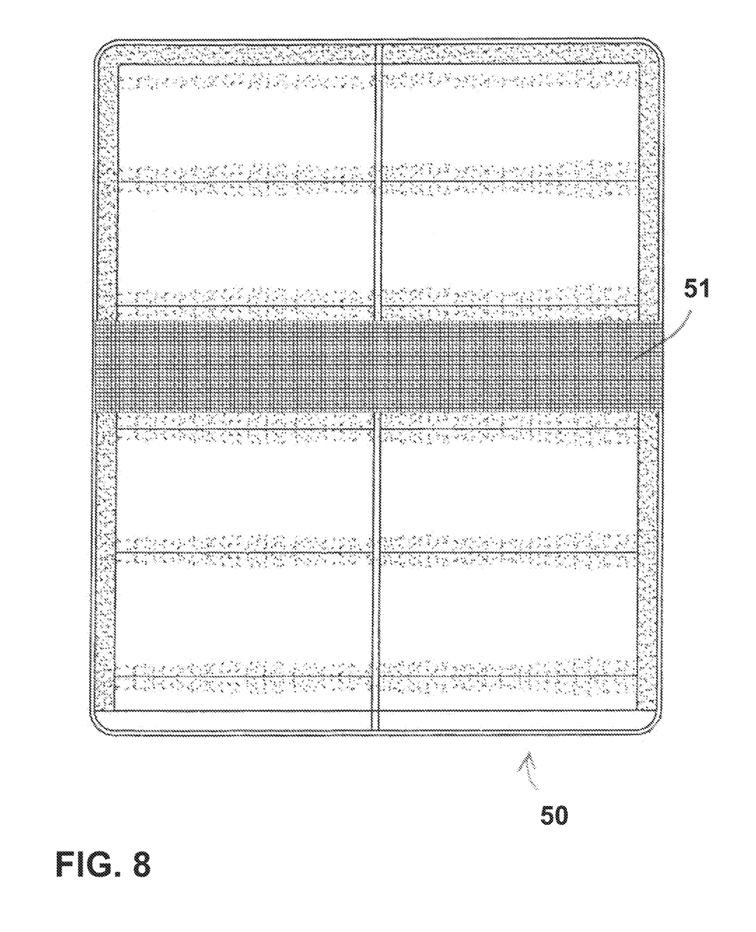

Referring now to FIGS. 7-8, an alternative support member is shown in the form of a sleeping bag 50, having a liner strip 51 therein formed from a fabric material having a low coefficient of friction, similar to that of the second fabric member 11. Where used, the liner strip 51 is sewn in place inside of the otherwise conventional sleeping bag 50, and extends around the entire inner surface of the sleeping bag, as shown. The sleeping bag 50 acts as a substitute for the bed 14 from the first embodiment, and is used in conjunction together with the first fabric member 16, as previously shown and described.

### Method of Using the System

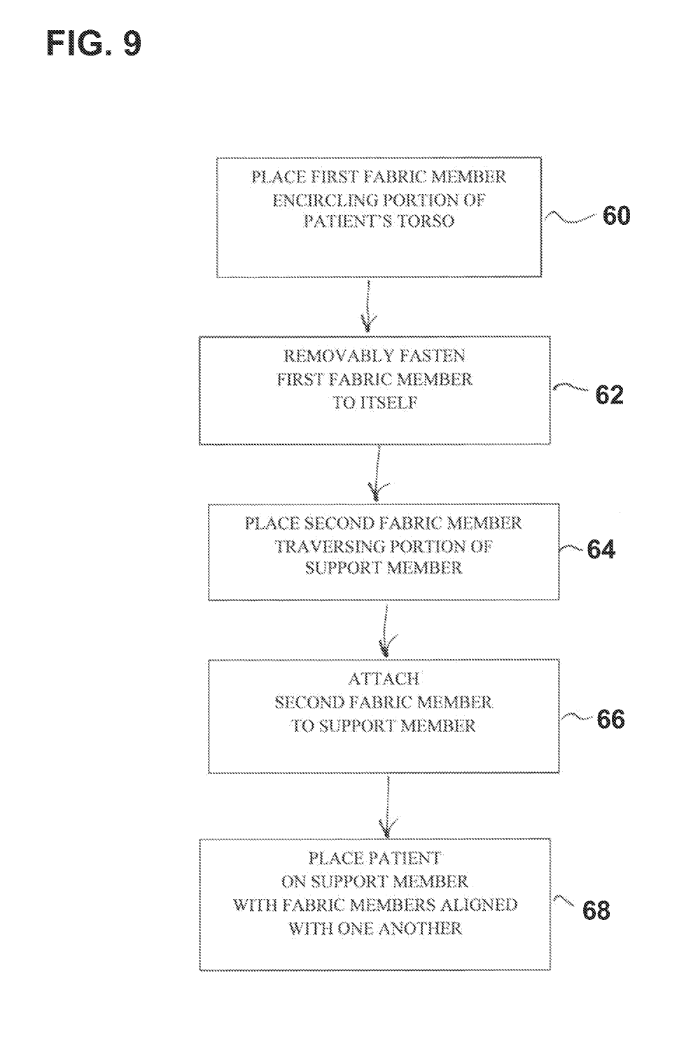

A diagram showing steps in an illustrative method according to the invention is shown in FIG. 9 of the present drawings.

The present invention also relates to a method of facilitating turning of a patient in a bed, the method comprising a first step 60 of wrapping a first fabric member 16 around a portion of a patient's torso.

The method hereof includes a step 62 of removably fastening the first fabric member 16 to itself to retain it in place on the patient, the first fabric member having an outer fabric surface having a low coefficient of friction.

The method hereof also involves a step 64 of placing a substantially rectangular second fabric member 11 traversing a portion of a support member 14.

The method hereof also includes a step 66 of removably attaching the second fabric member 11 to the support member 14, the second fabric member having an upper fabric surface having a low coefficient of friction.

The method hereof also involves a step 68 of placing the patient on the support member 14 in an orientation such that the outer surface of the first fabric member 16 is disposed on top of and contacting the upper surface of the second fabric member 11, whereby an amount of effort required to slidably move the patient relative to the support member is reduced.

Although the present invention has been described herein with respect to a limited number of presently preferred embodiments, the foregoing description is intended to be illustrative, and not restrictive. Those skilled in the art will realize that many modifications of the preferred embodiment could be made which would be operable. All such modifications, which are within the scope of the claims, are intended to be within the scope and spirit of the present invention.

I claim:

1. A movement-facilitating system for facilitating ease of a user's movement while the user is lying down on a support member, said system comprising:
a first fabric member configured to be wearable by the user, the first fabric member comprising a wrap cloth having an outer fabric surface having a low coefficient of friction and having a first fastener thereon at a first portion and a second fastener at an end portion thereof which is removably attachable to the first fastener; and
a second fabric member for placement traversing a portion of said support member, said second fabric member comprising:
a sheet member having an upper fabric surface having a low coefficient of friction; and
a sheet fastening component for use in operatively attaching the sheet member to a central portion of said support member.

2. The movement-facilitating system of claim 1, wherein the first and second fasteners of the first fabric member are selected from the group consisting of tie strings, snaps, hook and loop fasteners, and releasably securable plastic closure members such as side-release buckles.

3. The movement-facilitating system of claim 2, wherein the sheet fastening component of the second fabric member is selected from the group consisting of hook and loop fasteners, tie strings, and elastic bands with clip ends thereon, and releasably securable plastic closure members such as side-release buckles.

4. The movement-facilitating system of claim 1, wherein the second fabric member is configured to fit on a bed.

5. A movement-facilitating system for facilitating ease of a user's movement while the user is lying down on a support member, said system comprising:
a first fabric member configured to be wearable by the user, the first fabric member comprising a wrap cloth having an outer fabric surface having a low coefficient of friction and having a first fastener thereon at a first portion and a second fastener at an end portion thereof which is removably attachable to the first fastener; and
a sleeping bag comprising a second fabric member traversing and sewn into a central portion of said sleeping bag, said second fabric member comprising a sheet member having an upper fabric surface having a low coefficient of friction.

6. The movement-facilitating system of claim 5, wherein the first and second fasteners of the first fabric member are selected from the group consisting of tie strings, snaps, hook and loop fasteners, and releasably securable plastic closure members.

7. A method of facilitating turning of a patient in a bed, said method comprising the steps of:
a) wrapping a first fabric member around a portion of a patient's torso and removably fastening said first fabric member to itself, said first fabric member having an outer fabric surface having a low coefficient of friction;
b) placing a substantially rectangular second fabric member traversing a portion of a support member, and removably attaching said second fabric member to said support member, the second fabric member having an upper fabric surface having a low coefficient of friction;
c) placing the patient on the support member in an orientation such that the outer surface of the first fabric member is disposed on top of the upper surface of the second fabric member, whereby an amount of effort required to slidably move the patient relative to the support member is reduced.
